(19) United States
(12) Patent Application Publication
(10) Pub. No.: US 2017/0006007 A1
(43) Pub. Date: Jan. 5, 2017

(54) SEMICONDUCTOR DEVICE AND CONTROL METHOD OF SEMICONDUCTOR DEVICE

(71) Applicant: RENESAS ELECTRONICS CORPORATION, Tokyo (JP)

(72) Inventor: Yasutaka NAKASHIBA, lbaraki (JP)

(21) Appl. No.: 15/155,854

(22) Filed: May 16, 2016

(30) Foreign Application Priority Data
Jun. 30, 2015 (JP) 2015-131534

(51) Int. Cl. H04L 29/06; H04W 12/06; H04W 4/00

(52) U.S. Cl. CPC H04L 63/08; H04W 4/008; H04W 12/06

(57) ABSTRACT

A semiconductor device that can perform high speed data communication is provided.

The semiconductor device includes a communication chip that performs authentication processing that determines whether or not data communication can be performed with an external device and performs the data communication with the external device when the authentication processing is successfully performed and a control chip that performs data processing of transmission/reception of the data communication through the communication chip. The communication chip includes a first memory that stores authentication data for the authentication processing. The control chip includes a second memory for the data processing.

### CROSS-REFERENCE TO RELATED APPLICATIONS

The disclosure of Japanese Patent Application No. 2015-131534 filed on Jun. 30, 2015 including the specification, drawings and abstract is incorporated herein by reference in its entirety.

### BACKGROUND

The present disclosure relates to a semiconductor device, in particular, to a semiconductor device for communication.

In recent years, as a standard of short-range wireless data communication, Bluetooth (registered trademark) attracts attention. In the Bluetooth, size reduction and price reduction of wireless modules compatible with the Bluetooth have progressed, and further, power consumption of the wireless modules is low, so that it is easy to mount the wireless module in a mobile device such as a digital still camera and a mobile phone and it is possible to more easily transmit and receive data such as an image and voice between the mobile devices and between the mobile device and an information device such as a PC (personal computer). For example, Japanese Unexamined Patent Application Publication No. 2005-72864 discloses an electronic device that communicates by using a short-range wireless communication line of Bluetooth.

### SUMMARY

However, in a configuration disclosed in Japanese Unexamined Patent Application Publication No. 2005-72864, a memory that stores information related to the communication is provided separately from a control microcomputer and a communication module, so that there is a problem that it takes time to establish communication connection.

The present disclosure is made to solve the above problem and an object of the present disclosure is to provide a semiconductor device and a control method of a semiconductor device, which can perform high speed data communication.

Other objects and novel features will become apparent from the description of the present specification and the accompanying drawings.

According to an embodiment, a semiconductor device includes a communication chip that performs authentication processing that determines whether or not data communication can be performed with an external device and performs the data communication with the external device when the authentication processing is successfully performed and a control chip for controlling the data communication through the communication chip. The communication chip and the control chip include a first memory and a second memory, respectively. The first memory stores authentication data for the authentication processing.

According to an embodiment, the semiconductor device can perform high speed data communication.

### BRIEF DESCRIPTION OF THE DRAWINGS

FIG. 1 is a diagram for explaining a concept of a wireless communication system based on an embodiment.

FIG. 2 is a diagram for explaining a configuration of hardware of a camera 1 based on the embodiment.

FIG. 3 is a diagram for explaining a configuration of a control unit 10 based on the embodiment.

FIG. 4 is a diagram for explaining a structure of a control unit 10 based on the embodiment.

FIG. 5 is a diagram for explaining an internal configuration of a communication module 18 based on the embodiment.

FIG. 6 is a block diagram showing an internal configuration example of a television 2 based on the embodiment.

FIG. 7 is a diagram for explaining a screen that requests information of whether or not authentication data displayed on a monitor 15 should be registered based on the embodiment.

FIG. 8 is a flowchart for explaining authentication processing based on the embodiment.

FIG. 9 is a flowchart for explaining a method of storing authentication data based on a modified example 1 of the embodiment.

### DETAILED DESCRIPTION

An embodiment will be described in detail with reference to the drawings. In the drawings, the same or corresponding components are denoted by the same reference numerals and the description thereof will not be repeated.

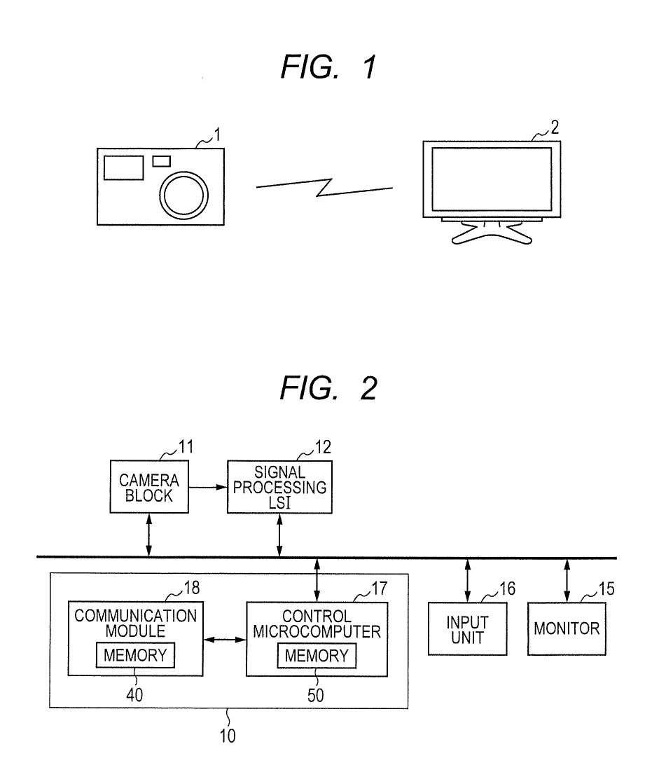

FIG. 1 is a diagram for explaining a concept of a wireless communication system based on the embodiment.

As show in FIG. 1, the wireless communication system includes a camera 1 and a television 2 that can communicate with the camera 1. This example is applied to a device that performs wireless communication in a relatively short range. The camera 1 records a captured still image in a recording medium as digital image data and wirelessly transmits the recorded image data to the television 2. The television 2 displays an image based on the image data transmitted from the camera 1.

FIG. 2 is a diagram for explaining a configuration of hardware of the camera 1 based on the embodiment.

As shown in FIG. 2, the camera 1 includes a camera block 11 that performs an image capturing function, a signal processing LSI 12 that performs analog-digital conversion and data format conversion processing of a captured image signal, a monitor 15 for displaying an image, an input unit 16 for inputting a user's operation, and a control unit 10 that controls the entire device. These components are coupled by a bus.

The control unit 10 includes a microcomputer (hereinafter referred to as a control microcomputer) 17 and a communication module 18 for wirelessly communicating with an external device.

The control microcomputer 17 is embedded with a memory 50. The communication module 18 is embedded with a memory 40.

The camera block 11 includes an optical system including a lens into which light from a subject enters, an iris, a shutter, and an image capturing element such as a CCD (Charge Coupled Device) which photoelectrically converts incident light.

The signal processing LSI 12 performs conversion processing of an output signal from the image capturing element into a digital signal, noise elimination processing of the output signal, image quality correction processing of the output signal, conversion processing of the output signal into a brightness/color difference signal, and encoding processing of the output signal into a predetermined data format such as the JPEG (Joint Photographic Coding Experts Group) standard.

The monitor 15 is composed of, for example, an LCD (Liquid Crystal Display). The monitor 15 can display a so-called camera through image which is captured by the camera block 11 and also can display an image read from the memory 50.

The input unit 16 includes, for example, a shutter release button for operating the shutter of the camera block 11 and a selection switch for selecting an operation mode. The input unit 16 outputs an instruction input signal according to an instruction of a user to the control unit 10.

The control unit 10 is a control processing unit that controls each circuit block. The control unit 10 controls each circuit block based on the instruction input signal from the input unit 16 while executing an application program stored in the embedded memory 40 as needed.

The communication module 18 is composed of, for example, an antenna and an RF (Radio Frequency) transceiver for transmitting and receiving a signal of a frequency hopping spread spectrum system and a processor that performs baseband processing and interface processing with the control microcomputer 17. The communication module 18 performs wireless communication with an external device such as the television 2 according to a communication procedure controlled by the control microcomputer 17.

Under the control of the control microcomputer 17, an image signal captured by the camera block 11 is displayed on the monitor 15 through the signal processing LSI 12. When the shutter of the camera block 11 is released by an instruction input signal from the input unit 16, the captured image signal is converted into digital data of a predetermined format by the signal processing LSI 12 and is recorded in the memory 50. Further, it is possible to read the image data recorded in the memory 50, decode the image data by the signal processing LSI 12, and display the generated image on the monitor 15, and furthermore, it is possible to wirelessly transmit the read image data to an external device such as the television 2 through the communication module 18.

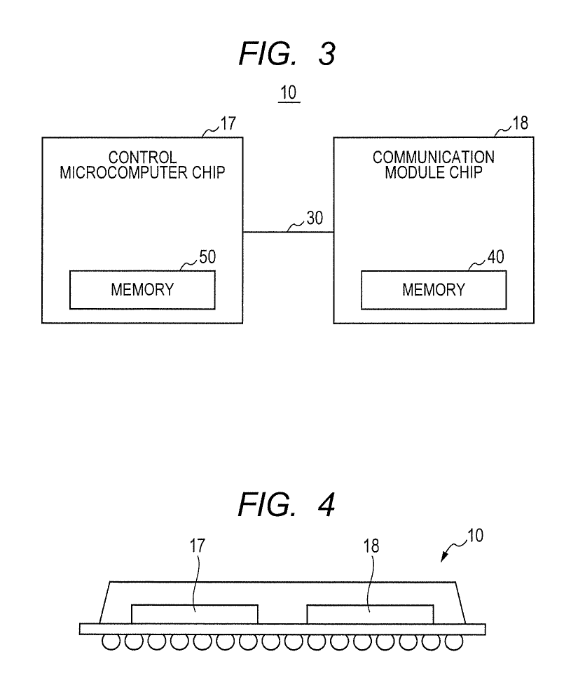

FIG. 3 is a diagram for explaining a configuration of the control unit 10 based on the embodiment.

As show in FIG. 3, the control unit 10 includes a control microcomputer chip 17 and a communication module chip 18. The control microcomputer chip 17 and the communication module chip 18 are electrically coupled to each other by wiring 30.

The communication module chip 18 includes the memory 40.

The control microcomputer 17 includes the memory 50.

As an example, at least one of the memories 40 and 50 is a non-volatile memory.

As the non-volatile memory, it is possible to use an EEPROM, a magneto resistive RAM (MRAM (Magneto resistive Random Access Memory)), a resistance change type memory (ReRAM (Resistance Random Access Memory)), a ferroelectric memory (FeRAM (Ferroelectric Random Access Memory)), and the like.

The memory 40 is a memory used for communication. The memory 40 stores authentication data used for authentication processing in the communication module 18. As the authentication data, as an example, a MAC address (Media Access Control address) can be used.

The memory 50 holds various application programs and necessary data for image capturing, image recording/reproducing operation, and wireless communication. The memory 50 temporarily stores data such as an image while the above operations are being performed.

FIG. 4 is a diagram for explaining a structure of the control unit 10 based on the embodiment.

As shown in FIG. 4, the control unit 10 is formed in a SiP (System in Package) structure.

Specifically, the communication module chip 18 and the control microcomputer chip 17 are mounted side by side on a printed wiring board. Data is transmitted and received between the communication module chip 18 and the control microcomputer chip 17 through the wiring of the printed wiring board.

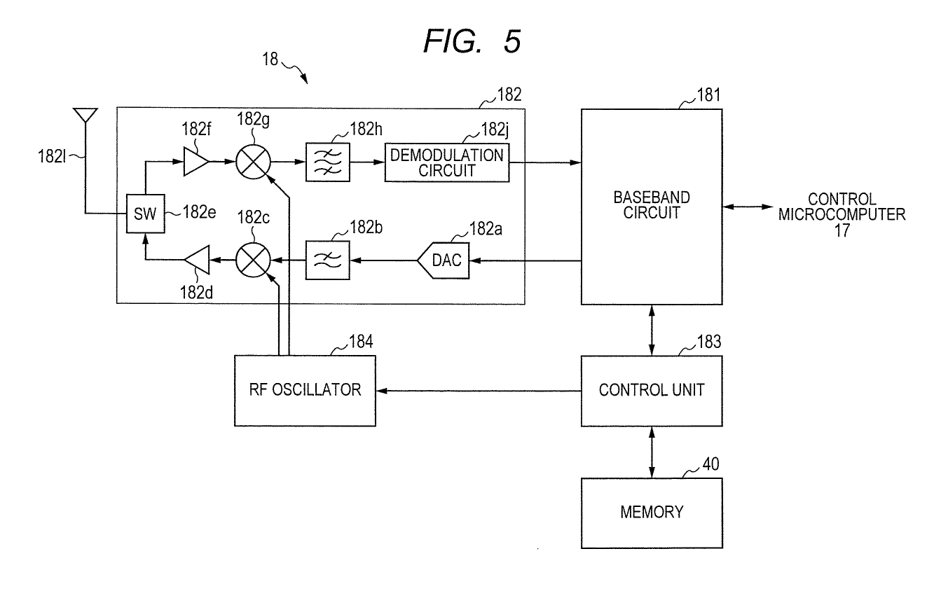

FIG. 5 is a diagram for explaining an internal configuration of the communication module 18 based on the embodiment.

As show in FIG. 5, the communication module 18 includes a baseband circuit 181, an RF transmission/reception circuit 182, a control unit 183, an RF oscillator 184, and a memory 40.

The baseband circuit 181 includes a signal processing circuit and the like for physical (RF) layer control and performs processing such as providing a communication link for data from the control microcomputer 17, re-transmitting a packet, and correcting an error under control of the control unit 183.

The RF transmission/reception circuit 182 includes a transmission circuit and a reception circuit for the wireless communication.

Specifically, for example, the RF transmission/reception circuit 182 includes a DAC (Digital-Analog Converter) 182a, a low-pass filter 182b, an IQ modulator 182c, a transmission amplifier 182d, an RF switch circuit 182e, a reception amplifier 182f, an IQ demodulator 182g, a band-pass filter 182h, a demodulation circuit 182j, and an antenna 182l.

A signal supplied from the baseband circuit 181 is converted into an analog signal by the DAC 182a and a high frequency component of the signal is cut off, and thereafter the signal is modulated by the IQ modulator 182c.

The IQ modulator 182c performs frequency hopping spread spectrum based on a reference wave from the RF oscillator 184. The modulated signal is amplified by the transmission amplifier 182d, supplied to the antenna 1821 through the RF switch circuit 182e, and wirelessly transmitted.

On the other hand, the signal received by the antenna 182l is supplied to the reception amplifier 182f through the RF switch circuit 182e and amplified, and thereafter demodulated by the IQ demodulator 182g based on the reference wave from the RF oscillator 184. Further, the signal is band-limited by the band-pass filter 182h, and then down-converted into an intermediate frequency by the demodulation circuit 182j, and supplied to the baseband circuit 181.

The control unit 183 controls each block in the communication module 18 according to information inputted from the control microcomputer 17 through the baseband circuit 181.

The RF oscillator 184 includes an oscillator and a PLL (Phase Locked Loop) and provides a reference wave for frequency hopping to the IQ modulator 182c and the IQ demodulator 182g according to control from the control unit 183.

The control unit 183 performs authentication processing with an external device by using authentication data stored in a memory 40.

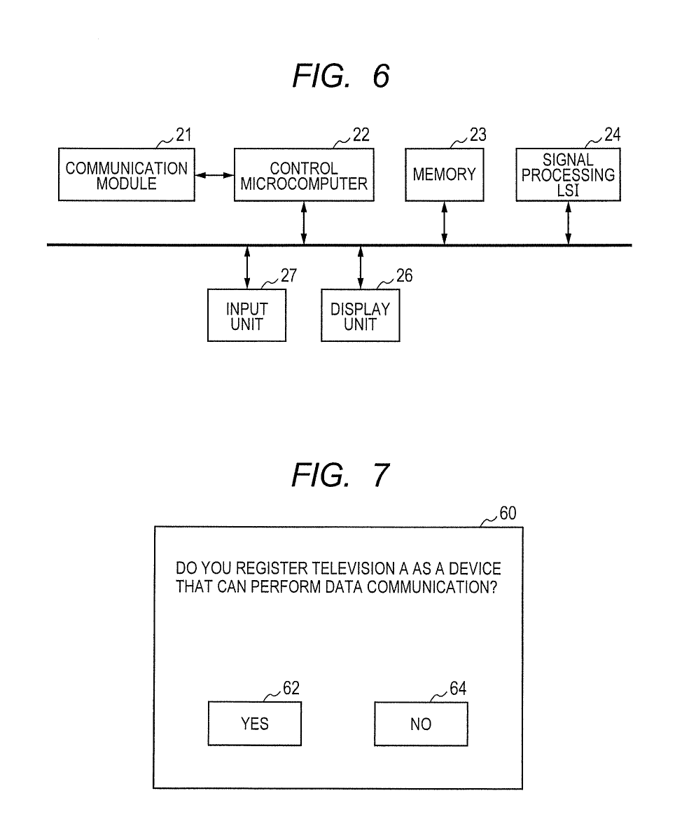

FIG. 6 is a block diagram showing an internal configuration example of the television 2 based on the embodiment.

As shown in FIG. 6, the television 2 is composed of a communication module 21 having the same function as that of the communication module, a control microcomputer 22 that controls the entire device, a memory 23 that temporarily stores data, a signal processing LSI 24 that performs signal processing for displaying resolution conversion processing of received image data and the like on a display unit 26, the display unit 26 that displays an image, and an input unit 27 for a user's manual operation, and these components are coupled by a bus.

The communication module 21 performs communication with the camera 1 under control of the control microcomputer 22. The control microcomputer 22 is a control processing unit that controls each circuit block in the television 2. The control microcomputer 22 controls each circuit block based on an instruction input signal from the input unit 27 and data received through the communication module 21 while executing an application program in the memory 23 as needed.

The memory 23 is composed of a ROM, a RAM, and the like. The memory 23 holds an application program and data for display control, wireless communication, and the like. Further, the memory 23 temporarily stores data when image data is received or the like.

The input unit 27 is composed of a button switch and the like that are operated by a user.

In such a television 2, wireless communication is performed with the camera 1 through the communication module 21 under control of the control microcomputer 22 and image data is received. Resolution conversion processing and the like are performed on the received image data by the signal processing LSI 24 and thereafter the image data is displayed on the display unit 26.

In general, in the case of wireless communication like Bluetooth, when one device couples to another device and the one device transmits a file and/or image data to the other device, the one device (master) first has to specify the other device (slave) to which the one device couples. In particular, when the one device couples to another device for the first time, in general, the one device searches for devices which are located around the one device and to which the one device can wirelessly communicate with and the one device selects a desired slave device from among detected devices and couples to the slave device.

FIG. 7 is a diagram for explaining a screen that requests information of whether or not authentication data displayed on the monitor 15 should be registered based on the embodiment.

As shown in FIG. 7, when a wirelessly communicable device which is coupled first is detected, a registration yes/no request screen 60 is displayed on the monitor 15.

In this example, in the registration yes/no request screen 60, a message “Do you register television A as a device that can perform data communication?” is displayed. Further, buttons 62 and 64 of “YES” and “NO” are provided on the screen.

For example, when the “YES” button 62 is selected by operating the input unit 16, authentication data is registered in the memory 40 to authenticate the television A.

When the “NO” button 64 is selected, authentication data to authenticate the television A is not registered in the memory 40.

Specifically, the control microcomputer 17 detects that a selection input of the “YES” button 62 of the input unit 16 is received and stores the authentication data of the television A in the memory 40 of the communication module 18.

Thereafter, the communication module chip 18 can perform authentication processing by using the authentication data stored in the memory 40.

FIG. 8 is a flowchart for explaining authentication processing based on the embodiment.

The authentication processing is performed by the control unit 10 of the camera 1.

As show in FIG. 8, the control unit 10 determines whether or not there is a response from an external device (for example, the television 2) (step S2). Specifically, the control unit 183 of the communication module 18 determines whether or not there is a response to a coupling request.

Subsequently, when the control unit 10 determines that there is a response (YES in step S2), the control unit 10 checks authentication data (step S4). Specifically, when the control unit 183 of the communication module 18 determines that there is a response to a coupling request, the control unit 183 checks authentication data included in the response.

Subsequently, the control unit 10 determines whether or not the authentication data corresponds (step S6). Specifically, the control unit 183 determines whether or not the received authentication data corresponds with the authentication data stored in the memory 50.

Subsequently, in step S6, when the control unit 10 determines that the received authentication data corresponds with the authentication data stored in the memory 50 (YES in step S6), the control unit 10 notifies that the authentication is OK (step S8). Specifically, when the control unit 183 determines that the received authentication data corresponds with the authentication data stored in the memory 50, the control unit 183 notifies the control microcomputer 17 that the authentication is OK.

Then, the processing is completed (End).

The control microcomputer 17 establishes a coupling link according to the notification of authentication OK from the communication module 18. Thereafter, data is transmitted to and received from an external device (as an example, the television 2) through the communication module 18. In this example, as an example, the image data stored in the memory 50 is transmitted to the television 2. Then, the image data transmitted from the cameral is displayed on the television 2.

On the other hand, in step S6, when the control unit 10 determines that the received authentication data does not correspond with the authentication data stored in the memory 50 (NO in step S6), the control unit 10 performs an authentication query request (step S10). Specifically, the control unit 183 of the communication module 18 outputs the authentication query request to the control microcomputer 17. The control microcomputer 17 displays the registration yes/no request screen 60 with respect to the authentication query request from the communication module 18.

Subsequently, the control unit 10 determines whether or not there is a registration (step S12). Specifically, the control microcomputer 17 determines whether or not there is a selection input of the “YES” button 62 in the registration yes/no request screen 60 according to an operation instruction of the input unit 16.

In step S12, when the control unit 10 determines that there is a registration (YES in step S12), the control unit 10 performs registration processing (step S14). Specifically, when there is a selection input of the “YES” button 62 in the registration yes/no request screen 60 according to an operation instruction of the input unit 16, the control microcomputer 17 stores the received authentication data in the memory 40 of the communication module 18.

Then, the control unit 10 notifies that the authentication is OK (step S8). Then, a coupling link is established.

Then, the processing is completed (End).

On the other hand, in step S12, when the control unit 10 determines that there is no registration (NO in step S12), the control unit 10 ends the processing (End). Specifically, when there is a selection input of the “NO” button 64 in the registration yes/no request screen 60 according to an operation instruction of the input unit 16, the control microcomputer 17 ends the processing. In this case, the received authentication data is not stored in the memory 40 of the communication module 18 and the coupling link is not established.

In the data communication based on the embodiment, the authentication data is stored in the memory 40 of the communication module 18, so that the authentication processing is performed in the communication module 18 and the coupling link is established.

Therefore, it is possible to perform the authentication processing earlier than a case where a memory is provided independently as in a related art, so that it is possible to perform data communication at high speed.

When the number of authentication data that can be registered in the memory 40 is limited, it is possible to limit external devices to be coupled, so that it is possible to surely couple to a target external device. Therefore, a coupling operation that is intuitive for a user can be realized.

In the above description, an example of storing authentication data for coupling with an external device in the memory 40 is described. However, authentication data of an external device not to be coupled may be stored in the memory 40. Specifically, when there is a selection input of the “NO” button 64 in the registration yes/no request screen 60, the received authentication data may be stored in the memory 40 as authentication data of an external device not to be coupled. Thereafter, when the received authentication data corresponds with the authentication data of the external device not to be coupled, which is stored in the memory 40, the processing may be completed without outputting an authentication query request. By this filtering, it is possible to reduce unnecessary processing and lower the power consumption.

When the communication module 18 includes the memory 40 for storing authentication data, it is possible to suppress the capacity of the memory 50 in the control microcomputer 17. Further, the capacity of the memory 40 for storing authentication data can be suppressed to be lower than the capacity of the memory 50. Therefore, it is possible to perform high-speed data communication while suppressing the chip areas of the communication module 18 and the control microcomputer 17 to be low.

It is preferable to form the communication module 18 by using transistors whose response characteristics are better than those of transistors included in the control microcomputer 17 in order to guarantee the high-speed circuit operation in the communication module 18.

It is possible to differentiate a voltage that drives the communication module 18 and a voltage that drives the control microcomputer 17 in order to suppress the power consumption. Specifically, it is possible to reduce the power consumption in the data communication by driving the communication module 18 by a voltage lower than the voltage that drives the control microcomputer 17.

When a configuration is employed in which the communication module is mixed into the control microcomputer, it is necessary to manufacture a control microcomputer according to the type of the communication module, so that there is a problem that the number of types of control microcomputers increases.

In the configuration according to the embodiment, the chip of the control microcomputer 17 and the chip of the communication module 18 are divided from each other, so that it is possible to suppress the number of types of the control microcomputers 17 to be manufactured. Further, it is possible to use a general-purpose control microcomputer, so that a freedom degree of selection of combination of the control microcomputer chip and the communication module chip is improved.

When the authentication data is stored only in the control microcomputer 17 and no authentication data is stored in the communication module 18, there is a problem of vulnerability of an interface between the communication module 18 and the control microcomputer 17. Specifically, when the authentication data is transmitted from the control microcomputer to the chip of the communication module, an average current is pushed up due to three-wire serial transmission, so that it takes time to transmit the authentication data. Therefore, there is a possibility that it takes time for initial authentication. On the other hand, in the configuration according to the embodiment, the authentication data need not be transmitted, so that it is possible to reduce the time used for the initial authentication.

### MODIFIED EXAMPLE 1

As another method, after power-on, the authentication data stored in the memory 50 of the control microcomputer 17 is outputted to the communication module 18. Then, the authentication data is stored in the memory 40 of the communication module 18 and the authentication processing may be performed by using the authentication data stored in the memory 40.

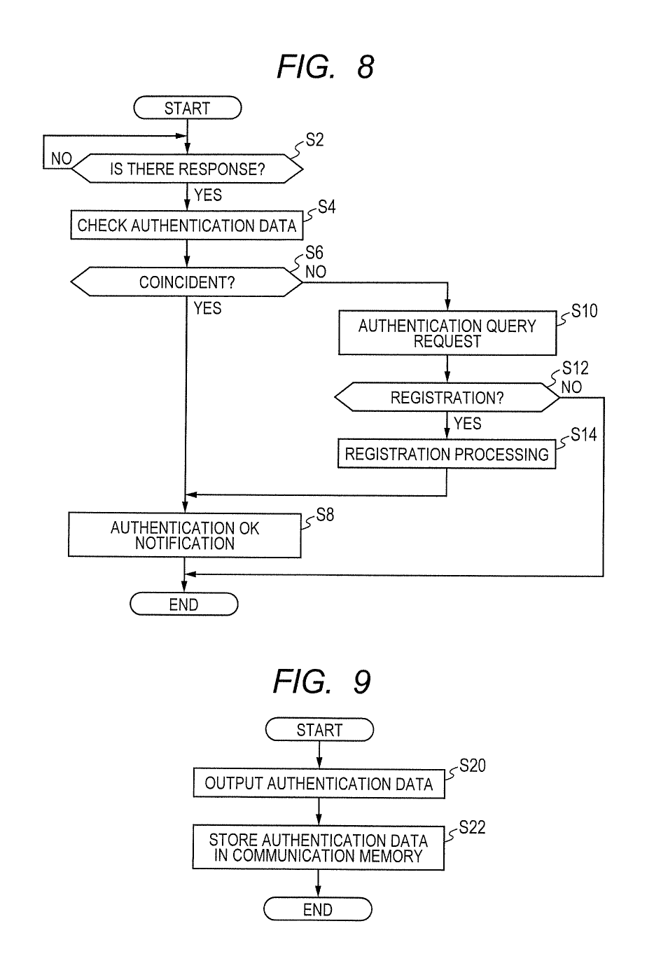

FIG. 9 is a flowchart for explaining a method of storing the authentication data based on a modified example 1 of the embodiment.

As shown in FIG. 9, after power-on, the control microcomputer 17 outputs the authentication data stored in the memory 50 to the communication module 18 (step S20).

The communication module 18 stores the authentication data outputted from the control microcomputer 17 through the wiring 30 in the memory 40 which is a communication memory (step S22).

Then, the processing is completed (End).

The communication module 18 performs the above-described authentication which determines whether or not data communication with an external device can be performed by using the authentication data stored in the memory 40.

The authentication data stored in the memory 50 of the control microcomputer 17 is moved to the memory 40 by storing the authentication data stored in the memory 50 into the memory 40. Then, the communication module 18 performs the authentication processing based on the authentication data moved to the memory 40.

Even if a failure occurs in data stored in the memory 40, it is possible to easily restore the data by using the authentication data managed in the memory 50. In the case of this method, a volatile memory such as a DRAM (Dynamic Random Access Memory) can be used as the memory 40, so that it is possible to reduce the power consumption more than when a non-volatile memory is used.

### MODIFIED EXAMPLE 2

In the modified example 1 described above, a case is described in which the authentication data stored in the memory 50 of the control microcomputer 17 is outputted to the memory 40 of the communication module 18.

In a modified example 2, a case will be described in which both of the memory 40 and the memory 50 hold the authentication data.

Specifically, one authentication data is registered in the memory 40 of the communication module 18. The authentication data of the other external devices that can be coupled are stored in the memory 50.

When data communication is performed with an external device that transmits the authentication data stored in the memory 40 of the communication module 18, it is possible to quickly perform the authentication processing and perform high-speed data communication.

On the other hand, when data communication is performed with an external device that transmits authentication data that is not stored in the memory 40 of the communication module 18, if the authentication data is received, the control microcomputer 17 determines whether or not the authentication data corresponds to the authentication data stored in the memory 50 of the control microcomputer 17. When the authentication data corresponds to the authentication data stored in the memory 50 of the control microcomputer 17, the control microcomputer 17 determines that the authentication is OK, establishes a coupling link, and performs data communication. Then, the control microcomputer 17 stores the authentication data where the authentication is determined to be OK into the memory 40 of the communication module 18. Thereby and thereafter, it is possible to quickly perform the authentication because the authentication data is stored in the memory 40.

By this configuration, it is possible to efficiently perform high-speed data communication by storing the authentication data in the memory 40 of the communication module 18 so that quick authentication can be performed and preliminarily storing the authentication data of the other communicatable external devices in the memory 50 of the control microcomputer 17 to authenticate the other external devices.

In the above description, a case is described in which image data stored in the memory 50 is transmitted to the television 2 by data communication. However, the transmitted data is not limited to image data, but various data such as voice data and other file data may be transmitted by data communication.

In the embodiment described above, the cameral that performs wireless communication with the television 2 is mainly described. However, the embodiment can be applied not only to the camera 1, but also to various terminals such as another image capturing device, a mobile phone, a PDA, and a remote control device. Although a case is described in which the camera 1 wirelessly communicates with the television 2 as an example of the external device, the external device is not limited to a television, but various electronic devices such as a PC and a printer device can be used.

Although the disclosure has been specifically described based on the embodiment, the disclosure is not limited to the embodiment, and needless to say that the disclosure can be variously modified without departing from the scope of the disclosure.

What is claimed is:

1. A semiconductor device comprising:
a communication chip that performs authentication processing that determines whether or not data communication can be performed with an external device and performs the data communication with the external device when the authentication processing is successfully performed; and
a control chip for controlling the data communication through the communication chip,
wherein the communication chip and the control chip include a first memory and a second memory, respectively, and
wherein the first memory stores authentication data for the authentication processing.

2. The semiconductor device according to claim 1,
wherein the communication chip includes
a transmission/reception circuit that transmits and receives data to and from the external device, and
a control circuit that controls the transmission/reception circuit, and
wherein the control circuit performs authentication processing that determines whether or not authentication data included in data received by the transmission/reception circuit corresponds with the authentication data stored in the first memory.

3. The semiconductor device according to claim 1,
wherein a capacity of the second memory is greater than that of the first memory.

4. The semiconductor device according to claim 1,
wherein at least one of the first memory and the second memory is a non-volatile memory.

5. The semiconductor device according to claim 1,
wherein a voltage that drives the communication chip is lower than a voltage that drives the control chip.

6. The semiconductor device according to claim 1,
wherein a transistor included in the communication chip is faster than a transistor included in the control chip.

7. The semiconductor device according to claim 1,
wherein the control chip outputs authentication data for the authentication processing, which is stored in the first memory of the communication chip, before the data communication.

8. The semiconductor device according to claim 1,
wherein the first memory stores one authentication data for the authentication processing, and
wherein the second memory stores another authentication data for the authentication processing.

9. The semiconductor device according to claim 1,
wherein the first memory is a volatile memory and the second memory is a non-volatile memory.

10. A control method of a semiconductor device including a communication chip that performs data communication with an external device and a control chip, the control method comprising the steps of:
performing authentication processing that determines whether or not data communication can be performed with an external device; and
performing the data communication with the external device when the authentication processing is successfully performed,
wherein the performing the authentication processing includes
receiving data from the external device, and
determining whether or not authentication data included in the received data corresponds with authentication data stored in a memory of the communication chip.
